(19) United States
(12) Patent Application Publication
(10) Pub. No.: US 2015/0114641 A1
(43) Pub. Date: Apr. 30, 2015

(54) PROPPANTS WITH IMPROVED FLOW BACK CAPACITY

(71) Applicant: Baker Hughes Incorporated, Houston, TX (US)

(72) Inventors: Naima Bestaoui-Spurr, The Woodlands, TX (US); Qi Qu, Spring, TX (US); Christopher J. Stephenson, Houston, TX (US)

(73) Assignee: Baker Hughes Incorporated, Houston, TX (US)

(21) Appl. No.: 14/066,918

(22) Filed: Oct. 30, 2013

(51) Int. Cl. C09K 8/80; E21B 43/267

(52) U.S. Cl. CPC C09K 8/80; E21B 43/267
USPC 166/280.2; 507/269

(57) ABSTRACT

A deformable particulate material made of cement materials such as aluminosilicate cement and having an aspect ratio of greater than 1 to about 25 may be mixed with conventional proppants to give a blend with improved flow back capacity when the blend is injected into a hydraulic fracture created in a subterranean formation.

### TECHNICAL FIELD

The present invention relates to proppants used in hydraulic fracturing treatments for subterranean formations, and more particularly relates to methods for making blends of proppants and proppant materials that have reduced proppant flow back once the blend is placed within the fracture.

### TECHNICAL BACKGROUND

Hydraulic fracturing is a common stimulation technique used to enhance production of hydrocarbon fluids from subterranean formations. In a typical hydraulic fracturing treatment, fracturing treatment fluid containing a solid proppant material is injected into the formation at a pressure sufficiently high enough to cause the formation to fracture or cause enlargement of natural fractures in the reservoir. The fracturing fluid that contains the proppant or propping agent typically has its viscosity increased by a gelling agent such as a polymer, which may be uncrosslinked or crosslinked, and/or a viscoelastic surfactant. During a typical fracturing treatment, propping agents or proppant materials are deposited in a fracture, where they remain after the treatment is completed. After deposition, the proppant materials serve to hold the fracture open, thereby enhancing the ability of fluids to migrate from the formation to the well bore through the fracture. Because fractured well productivity depends on the ability of a fracture to conduct fluids from a formation to a wellbore, fracture conductivity is an important parameter in determining the degree of success of a hydraulic fracturing treatment and the choice of proppant may be critical to the success of stimulation.

One problem related to hydraulic fracturing treatments is the creation of reservoir “fines” and associated reduction in fracture conductivity. These fines may be produced when proppant materials are subjected to reservoir closure stresses within a formation fracture which cause proppant materials to be compressed together in such a way that small particles (“fines”) are generated from the proppant material and/or reservoir matrix. In some cases, production of fines may be exacerbated during production/workover operations when a well is shut-in and then opened up. This phenomenon is known as “stress cycling” and is believed to result from increased differential pressure and closure stress that occurs during fluid production following a shut-in period. Production of fines is undesirable because of particulate production problems, and because of reduction in reservoir permeability due to plugging of pore throats in the reservoir matrix.

Production of particulate solids with subterranean formation fluids is also a common problem. The source of these particulate solids may be unconsolidated material from the formation, proppant from a fracturing treatment and/or fines generated from crushed fracture proppant, as mentioned above. Production of solid proppant material is commonly known as “proppant flowback.” In addition to causing increased wear on downhole and surface production equipment, the presence of particulate materials in production fluids may also lead to significant expense and production downtime associated with removing these materials from wellbores and/or production equipment. Accumulation of these materials in a well bore may also restrict or even prevent fluid production. In addition, loss of proppant due to proppant flowback may also reduce conductivity of a fracture pack.

Proppant-like deformable particles have been used in order to minimize proppant flow back problems. However current deformable particles that use a traditional phenolic resin coating may be restricted for certain applications and locations, meaning that these coatings are not biodegradable and not environmentally friendly that they may have environmental concerns.

It will be appreciated that if inert inorganic flexible particles proppant can be prepared that at least three problems are addressed. First, proppants with inert inorganic compositions are more environmentally friendly. Second, such deformable proppants do not disintegrate and exacerbate the production of fines and can be used at higher stresses and temperatures than conventional deformable particles. However, a problem with previous deformable particles which are polymers is that while they do not produce fines, they will become compressed and decrease the proppant pack conductivity. Third, proppant flowback may be consequently reduced, so that more of the proppants and proppant materials remain within the fracture to be effective. Thus, it would be very desirable to discover methods to produce inert deformable proppants.

### SUMMARY

There is provided, in one non-limiting form, a blend comprising deformable particulate material having an aspect ratio of greater than 1 to about 25 and comprising a material selected from the group consisting of aluminosilicate, magnesium phosphate, aluminum phosphate, zirconium aluminum phosphate, zirconium phosphate, zirconium phosphonate, carbide materials such as tungsten carbide, polymer cements, high performance polymers such as polyamide-imides and polyether ether ketones (PEEK), and combinations thereof, and fracture proppant material.

In another non-restrictive embodiment, there is provided a method of fracturing a subterranean formation, which method includes injecting a blend into a hydraulic fracture created in a subterranean formation. The blend comprising deformable particulate material having an aspect ratio of greater than 1 to about 25 and comprising a material selected from the group consisting of aluminosilicate, magnesium phosphate, aluminum phosphate, zirconium aluminum phosphate, zirconium phosphate, zirconium phosphonate, carbide materials such as tungsten carbide, polymer cements, high performance polymers, meaning they can withstand high temperature (more than 150° C.) and are chemically resistant, such as polyamide-imides and polyether ether ketones (PEEK), and combinations thereof, and fracture proppant material, where the method further includes flowing fluid back through the blend where the amount of the fracture proppant material flowed back is less than the fracture proppant material flowed back in the absence of the deformable particulate material.

There is additionally provided in another non-limiting, more detailed embodiment a method of fracturing a subterranean formation that includes injecting a blend into a hydraulic fracture created in a subterranean formation. The blend comprises deformable particulate material having an aspect ratio of greater than 1 to about 25 and comprising a material selected from the group consisting of aluminosilicate, magnesium phosphate, aluminum phosphate, zirconium aluminum phosphate, zirconium phosphate, zirconium phosphonate, carbide materials such as tungsten carbide, polymer cements, high performance polymer such as polyamide-imide and polyether ether ketones (PEEK), and combinations thereof, and fracture proppant material that includes, but is not necessarily limited to, white sand, brown sand, ceramic beads, glass beads, bauxite grains, sintered bauxite, sized calcium carbonate, walnut shell fragments, aluminum pellets, nylon pellets, nuts shells, gravel, resinous particles, alumina, minerals, polymeric particles, and combinations thereof. In the blend, the fracture proppant material has a particle size of from about 4 mesh to about 100 mesh (from about 5 mm to about 0.1 mm), the deformable particulate material has a particle size of from about 4 mesh to about 100 mesh (from about 5 mm to about 0.1 mm), and the ratio of fracture proppant material to deformable particulate material ranges from about 20:1 to about 0.5:1 by volume. The method further includes flowing fluid back through the blend where the amount of proppants flowed back is reduced from about 10 wt % or more less proppant produced to 100 wt %.

### BRIEF DESCRIPTION OF THE DRAWINGS

FIG. 1 is a micrograph of two particles made of sand and geopolymer, where the upper particle is as-prepared, and the lower particle is a very similar one after having been pressed between two layers of sand at 5,550 psi (about 38 MPa).

### DETAILED DESCRIPTION

In order to obtain particles that are environmentally inert, it has been discovered that cements may be used to make new flow back control deformable particulate materials or granules. These cements or geopolymers are light weight aluminosilicate cements that are considered “green” materials because they may be synthesized from natural resources and their chemistry is environmentally friendly without the production of toxic residues or carbon dioxide (CO₂) emissions. They are a class of inorganic polymers formed by the reaction of an alkaline solution and an aluminosilicate source. However, unlike glass, these materials may be formed at relatively low temperatures through a sol-gel reaction. They are known to be adhesive, castable, extrudable, sprayable and strong. They are very durable, with high compressive strength, they are acid resistant and cost efficient. They are further inert to adverse reactions and effects with the surrounding environment.

More specifically, a method and composition is described to produce deformable particulate materials with a strength permitting its usage in formation closing or closure stresses from at least about 1000 (6.9 MPa), up to about 10,000 (69 MPa) and in one non-limiting embodiment up to about 12,000 psi (83 MPa). By “withstanding” closure stresses in this range is meant that the deformable particulate material will not be crushed or disintegrated at these closure stresses.

The deformable particulate materials are slightly lighter than sand and their apparent density is expected to range between about 1.7 independently to about 2.63 g/cm³, alternatively from between about 1.75 independently to about 2.3 g/cm³. The term “independently” as used herein with respect to a parameter range means that any lower threshold may be combined with any upper threshold to provide a suitable, acceptable alternative range.

Inorganic polymers used as the deformable particulate materials may be made by mixing an alkali metal hydroxide/silicate solution and aluminosilicate binder which results in a very strong, rigid network. The resulting deformable particulate materials have an amorphous, three dimensional structure similar to that of an aluminosilicate glass. The polymerization is thermally triggered to form a solid polymer at mild heat causing silicon and aluminum hydroxide molecules to poly-condense or polymerize, forming rigid chains or nets of oxygen bonded tetrahedra. The physical properties of the resultant rigid chain or net of geopolymer are largely determined by the ratio of silica and aluminum in the geopolymer. By varying this ratio, the material may be made rigid, suitable for use as a concrete, cement, or waste encapsulating medium, or more flexible for use as an adhesive, sealant or as an impregnating resin. The process may involve mixing the metal hydroxide/silicate solution with the aluminosilicate binder when exposing the mixture to a heat gun or other heat source for less than about ten minutes to trigger polymerization. The resulting deformable particulate material may or not then be put in an oven for about three hours to finish the polymerization process, if necessary.

Commonly used binders include class-F fly ash, ground granulated slag and metakaolin, but any fine amorphous aluminosilicate may be used. Similarly to conventional organic polymerization, the process involves thermally triggering monomer solutions to polymerize and form a solid polymer.

The other component of the blend is a fracture proppant material, which may include, but not necessarily be limited to, white sand, brown sand, ceramic beads, glass beads, bauxite grains, sintered bauxite, sized calcium carbonate, walnut shell fragments, aluminum pellets, nylon pellets, nuts shells, gravel, resinous particles, alumina, minerals, polymeric particles, and combinations thereof.

Examples of suitable ceramics include, but are not necessarily limited to, oxide-based ceramics, nitride-based ceramics, carbide-based ceramics, boride-based ceramics, silicide-based ceramics, or a combination thereof. In a non-limiting embodiment, the oxide-based ceramic may include, but is not necessarily limited to, silica (SiO₂), titania (TiO₂), aluminum oxide, boron oxide, potassium oxide, zirconium oxide, magnesium oxide, calcium oxide, lithium oxide, phosphorous oxide, and/or titanium oxide, or a combination thereof. The oxide-based ceramic, nitride-based ceramic, carbide-based ceramic, boride-based ceramic, or silicide-based ceramic may contain a nonmetal (e.g., oxygen, nitrogen, boron, carbon, or silicon, and the like), metal (e.g., aluminum, lead, bismuth, and the like), transition metal (e.g., niobium, tungsten, titanium, zirconium, hafnium, yttrium, and the like), alkali metal (e.g., lithium, potassium, and the like), alkaline earth metal (e.g., calcium, magnesium, strontium, and the like), rare earth (e.g., lanthanum, cerium, and the like), or halogen (e.g., fluorine, chlorine, and the like). Exemplary ceramics include, but are not necessarily limited to, zirconia, stabilized zirconia, mullite, zirconia toughened alumina, spinel, aluminosilicates (e.g., mullite, cordierite), perovskite, silicon carbide, silicon nitride, titanium carbide, titanium nitride, aluminum carbide, aluminum nitride, zirconium carbide, zirconium nitride, iron carbide, aluminum oxynitride, silicon aluminum oxynitride, aluminum titanate, tungsten carbide, tungsten nitride, steatite, and the like, or a combination thereof.

Examples of suitable sands for the fracture proppant material include, but are not limited to, Arizona sand, Wisconsin sand, Badger sand, Brady sand, and Ottawa sand. In a non-limiting embodiment, the solid particulate may be made of a mineral such as bauxite which is sintered to obtain a hard material. In another non-restrictive embodiment, the bauxite or sintered bauxite has a relatively high permeability such as the bauxite material disclosed in U.S. Pat. No. 4,713,203, the content of which is incorporated by reference herein in its entirety.

In another non-limiting embodiment, the fracture proppant material may be a relatively lightweight or substantially neutrally buoyant particulate material or a mixture thereof. Such materials may be chipped, ground, crushed, or otherwise processed. By “relatively lightweight” it is meant that the solid particulate has an apparent specific gravity (ASG) which is less than or equal to 2.45, including those ultra lightweight materials having an ASG less than or equal to 2.25, alternatively less than or equal to 2.0, in a different non-limiting embodiment less than or equal to 1.75, and in another non-restrictive version less than or equal to 1.25 and often less than or equal to 1.05.

Naturally occurring solid particulates include, but are not necessarily limited to, nut shells such as walnut, coconut, pecan, almond, ivory nut, brazil nut, and the like; seed shells of fruits such as plum, olive, peach, cherry, apricot, and the like; seed shells of other plants such as maize (e.g., corn cobs or corn kernels); wood materials such as those derived from oak, hickory, walnut, poplar, mahogany, and the like. Such materials are particles may be formed by crushing, grinding, cutting, chipping, and the like.

Suitable relatively lightweight solid particulates are those disclosed in U.S. Pat. Nos. 6,364,018, 6,330,916 and 6,059,034, all of which are herein incorporated by reference in their entirety.

Other solid particulates for use herein include beads or pellets of nylon, polystyrene, polystyrene divinyl benzene or polyethylene terephthalate such as those set forth in U.S. Pat. No. 7,931,087, also incorporated herein by reference in its entirety.

Fracture proppant material sizes and deformable particulate material sizes may be any size suitable for use in a fracturing treatment of a subterranean formation. It is believed that the optimal size of particulate material relative to fracture proppant material may depend, among other things, on in situ closure stress. For example, a fracture proppant material may be desirable to withstand a closure stress of at least about 1000 psi (6.9 MPa), alternatively of at least about 5000 psi (34 MPa) or greater, up to 10,000 psi (69 MPa), even without deformable particles. However, it will be understood with benefit of this disclosure that these are just optional guidelines. In one embodiment, the deformable proppants used in the disclosed method may have a beaded shape or spherical shape and a size of from about 4 mesh independently to about 100 mesh, alternatively from about 8 mesh independently to about 60 mesh, alternatively from about 12 mesh independently to about 50 mesh, alternatively from about 16 mesh independently to about 40 mesh, and alternatively about 20/40 mesh. Thus, in one embodiment, the proppants may range in size from about 1 or 2 mm independently to about 0.1 mm; alternatively their size will be from about 0.2 mm independently to about 0.8 mm, alternatively from about 0.4 mm independently to about 0.6 mm, and alternatively about 0.6 mm. However, sizes greater than about 2 mm and less than about 0.1 mm are possible as well.

Suitable shapes for the deformable particulate materials and the fracture proppant materials include, but are not necessarily limited to, beaded, cubic, bar-shaped, cylindrical, or a mixture thereof. Shapes of the proppants may vary, but in one embodiment may be utilized in shapes having maximum length-based aspect ratio values, in one exemplary embodiment having a maximum length-based aspect ratio of less than or equal to about 25, alternatively of from greater than one independently to less than or equal to about 20, alternatively of less than or equal to about 7, and further alternatively of less than or equal to about 5, in another non-limiting case less than about 4, alternatively less than about 3, or even 2 or less. In yet another exemplary embodiment, shapes of such proppants may have maximum length-based aspect ratio values of from greater than about 1 independently to about 25, alternatively from greater than about 1 independently to about 20, alternatively from greater than about 1 independently to about 7, and further alternatively from greater than about 1 independently to about 5. In yet another exemplary embodiment, such proppants may be utilized in which the average maximum length-based aspect ratio of particles present in a sample or mixture containing only such particles ranges from about 1 independently to about 25, alternatively from about 1 independently to about 20, alternatively from about 2 independently to about 15, alternatively from about 2 independently to about 9, alternatively from about 4 independently to about 8, alternatively from about 5 independently to about 7, and further alternatively is about 7.

The deformable particulate material may include, but not necessarily be limited to, aluminosilicate, magnesium phosphate, aluminum phosphate, zirconium aluminum phosphate, zirconium phosphate, zirconium phosphonate, magnesium potassium phosphate, carbide materials such as tungsten carbide, polymer cements, high performance polymers such as polyamide-imide and polyether ether ketones (PEEK), and combinations thereof. “High performance polymers” means that they have high temperature tolerance (more than 150° C.) and are chemically resistant. By “tolerance” is meant that the deformable particulate materials maintain their structural integrity, that is, they do not break down into smaller fragments up to at least this temperature, or when they contact chemicals up to at least this temperature. As noted, geopolymers are made by the reaction of an alkaline solution, including, but not necessarily limited to NaOH and/or KOH, and an aluminosilicate source by the application of low temperature (heating) through a sol-gel reaction. These inorganic polymers are considered “green” or environmentally advantageous, because they are synthesized from natural resources and their chemistry does not adversely affect the environment.

An alkaline solution is required to cause the geopolymerization reaction; this could be a monovalent alkali metal hydroxide including, but not necessarily limited to, potassium hydroxide, sodium hydroxide, and the like. If a divalent alkali metal hydroxide is used, the solubility will decrease, and some amount of a monovalent alkali metal hydroxide may be necessary or helpful in order to initiate the reaction.

In the specific, non-limiting case of forming the aluminosilicate deformable particulate materials, the mole ratio of SiO₂/Al₂O₃ ranges from about 1:1 independently to about 30:1; alternatively from about 1:1 independently to about 6:1. In one non-limiting embodiment, polymers such as, but not necessarily limited to, CMC (carboxymethyl cellulose), guar, guar derivatives, and the like may be included to improve the flexibility of the materials. In one non-limiting embodiment, these materials may be useful for flow back control, particularly in the embodiment where the deformable particulate materials may be deformable—this may help the proppant stay in place. As noted, these materials may be used together with conventional proppants. It is expected that flowing fluid back through the blend described herein where the amount of the proppants flowed back is less than the amount of otherwise identical proppants flowed back, where the otherwise identical proppants have an absence of the deformable particulate materials described herein. In one non-limiting version, the amount of proppants flowed back is reduced from about 10 wt % or more less proppant produced to 100 wt %; alternatively, the amount of proppants flowed back is reduced from about 20 wt % or more less proppant produced to 80 wt %.

In another non-restrictive version, the mole ratio of SiO₂ to alkali metal hydroxide or alkali metal oxide (e.g. Na₂O or K₂O) ranges from about 0.1:1 independently to about 6:1; alternatively from about 0.67:1 independently to about 2:1. Suitable ratios include, but are not necessarily limited to about 1.3:1 and about 1.52:1; either of which may be suitable alternative lower or upper thresholds of a range.

A suitable temperature range to initiate the polymerization of the deformable particulate materials may range from about 20° C. independently to about 300° C.; alternatively from about 60° C. independently to about 200° C. Alternatively, 20° C. may be defined for all purposes herein as “room temperature”, which may also be understood to range from about 19° C. to about 26° C.

A suitable temperature range to further complete or cure the polymerization of the deformable particulate materials may range from about 20° C. independently to about 300° C.; alternatively from about 20° C. independently to about 200° C.

Additives, such as fillers, plasticizers, cure accelerators and retarders, and rheology modifiers may be used in the deformable particulate materials described herein in order to achieve desired economical, physical, and chemical properties of the deformable particulate materials during the mixing of the chemical components, forming and cure of the particles, and the field performance of the proppants.

The deformable particulate materials or granules may be formed by any extrusion process known in the art of making proppants. “Extrusion” may be understood as a process that consistently forms granules, pellets, particulate materials and the like which have an aspect ratio of greater than 1, particularly on a continuous basis. The deformable particulate materials or granules may be shaped by continuous extrusion and a size reduction step or method including, but not necessarily limited to cutting, chopping, slicing, severing, and the like.

Compatible fillers for the deformable particulate materials include, but are not necessarily limited to, waste materials such as Kevlar fibers, fly ash, sludges, slags, waste paper, rice husks, saw dust, and the like, volcanic aggregates, such as expanded perlite, pumice, scoria, obsidian, and the like, minerals, such as diatomaceous earth, mica, borosilicates, clays, metal oxides, metal fluorides, and the like, plant and animal remains, such as sea shells, coral, hemp fibers, and the like, manufactured fillers, such as silica, mineral fibers and mats, chopped or woven fiberglass, metal wools, turnings, shavings, wollastonite, silica sand, nanoclays, carbon nanotubes, carbon fibers and nanofibers, graphene oxide, or graphite.

The ratio of fracture proppant material to deformable particulate material ranges from about 20:1 (or about 5% by volume deformable particulate material) independently to about 0.5:1 (or about 67% by volume deformable particulate material) by volume of total volume of the blend or mixture of fracture proppant material/fracture proppant material. Alternatively, a ratio of fracture proppant material to deformable particulate material ranges from about 1:1 independently to about 15:1 by volume of total volume of the blend or mixture of fracture proppant material/fracture proppant material. In a different nonrestrictive embodiment, the ratio of fracture proppant material to deformable particulate material is from about 3:1 independently to about 7:1 by volume; alternatively about 3.5 to independently about 6:1 by volume.

In another non-limiting embodiment injecting or introducing the deformable particulate material without mixing with fracture proppant material into the near wellbore region of the fracture (whether naturally existing or hydraulically created) is expected to improve conductivity when reservoir fluids are flowed back through the fracture. In this embodiment the strength of the deformable particulate material or granules is increased by the mole ratio of SiO₂ to alkali metal hydroxide or alkali metal oxide ranges from about 0.25:1 to about 8:1. By “near wellbore region” is meant within 15 feet (4.6 m) of the wellbore in one non-limiting version, alternatively within 10 feet (3 m) of the wellbore. The conductivity is expected to be improved as compared with an otherwise identical method where the particles are a conventional proppant. In one non-limiting embodiment, the improvement is at least 20%; alternatively at least 10%. In one non-limiting embodiment, conventional proppants are defined herein as those comprising a material different from the deformable particulate materials, and alternatively in another non-restrictive embodiment include, but are not necessarily limited to, white sand, brown sand, ceramic beads, glass beads, bauxite grains, sintered bauxite, sized calcium carbonate, walnut shell fragments, aluminum pellets, nylon pellets, nuts shells, gravel, resinous particles, alumina, minerals, polymeric particles, and combinations thereof.

The invention will now be described with respect to particular embodiments of the invention which are not intended to limit the invention in any way, but which are simply to further highlight or illustrate the invention.

### Example 1

The following example is provided to prove the validity of application of geopolymers used for flow back control. Samples were prepared by mixing 40.04 g of ground brown sand to 74.38 g of kaolinite heated at 750° C. to remove any moisture and 1.48 g of Kevlar fibers (the Kevlar fiber was added to improve the strength of the geopolymer, replacing it with a natural fibrous material such as wollastonite will yield the same or similar improvement in strength). To this mixture was added 109 g of sol, which was prepared by dissolving 40 g of silica in 140 g of 10 M NaOH solution. The resulting slurry was mixed for 5 minutes with a mixer at the highest speed, and then several 1 mL syringes were filled with this slurry. After about 1 hour the slurry solidified and the samples were left curing. After 24 hours, the samples were removed from the syringes and cut in smaller pieces in the longitudinal direction (having aspect ratios ranging from 2:1 to 3:1), and left curing at room temperature for three more days.

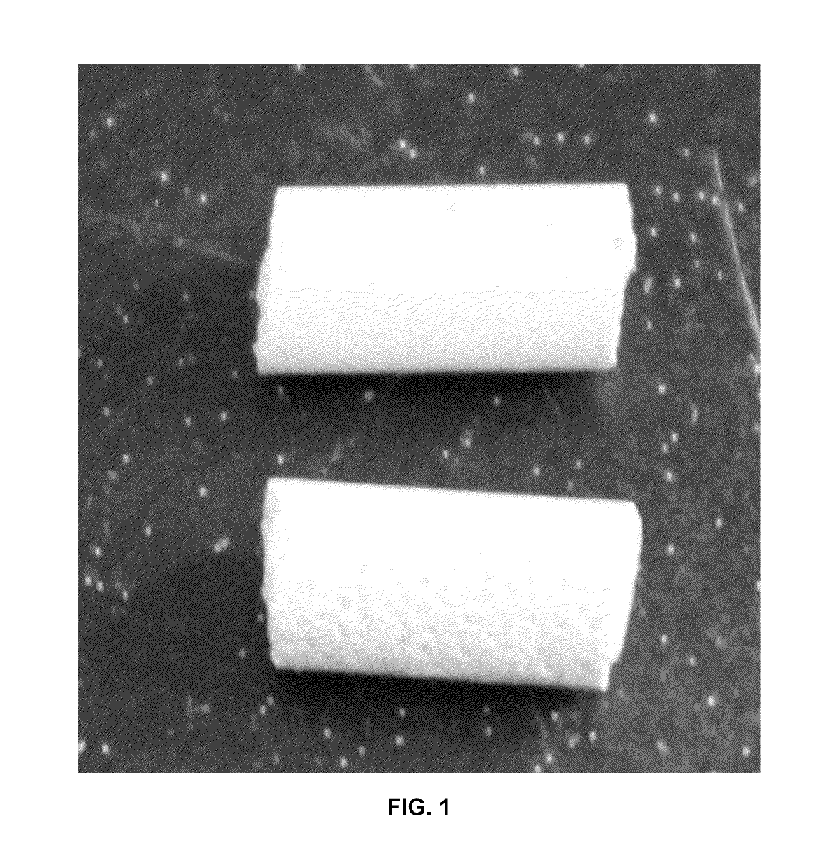

A piece of the geopolymer was then sandwiched between two layers of sand and pressed at 5,550 psi (about 38 MPa) for two minutes. FIG. 1 presents a micrograph of one of the particles before and after the sample was exposed to the 5,550 psi (about 38 MPa) pressure. The results look very encouraging as the surface of the pressed sample compared to the sample before compression shows dimples due to sand particles (20/40 mesh; 0.841/0.4 mm) that impacted the surface, indicating the flexibility of the material and its applicability as deformable particles for flow back control. As the proppant is exposed to pressure, the geopolymer particles should retain the proppant that is at its vicinity resulting in flow back control.

It is to be understood that the invention is not limited to the exact details of procedures, operation, exact materials, or embodiments shown and described, as modifications and equivalents will be apparent to one skilled in the art. Accordingly, the invention is therefore to be limited only by the spirit and scope of the appended claims. Further, the specification is to be regarded in an illustrative rather than a restrictive sense. For example, specific combinations of proppants, deformable particulate materials, fracture proppant materials, reactants, reaction conditions to form the deformable particulate materials, hydraulic fracturing method steps, and the like, falling within the claimed parameters, but not specifically identified or tried in a particular method, are anticipated to be within the scope of this invention.

The terms “comprises” and “comprising” in the claims should be interpreted to mean including, but not limited to, the recited elements.

The present invention may suitably comprise, consist or consist essentially of the elements disclosed and may be practiced in the absence of an element not disclosed. For instance, there may be provided a blend consisting essentially of or consisting of deformable particulate material having an aspect ratio of greater than 1 to about 25 and comprising a material selected from the group consisting of aluminosilicate, magnesium phosphate, aluminum phosphate, zirconium aluminum phosphate, zirconium phosphate, zirconium phosphonate, carbide materials, tungsten carbide, polymer cements, high performance polymers, polyamide-imides and polyether ether ketones (PEEK), and combinations thereof, and fracture proppant materials.

There is further provided a method of fracturing a subterranean formation, the method consisting of or consisting essentially of injecting a blend into a hydraulic fracture created in a subterranean formation, where the blend includes deformable particulate material having an aspect ratio of greater than 1 to about 25 and comprising a material selected from the group consisting of aluminosilicate, magnesium phosphate, aluminum phosphate, zirconium aluminum phosphate, zirconium phosphate, zirconium phosphonate, carbide materials, tungsten carbide, polymer cements, high performance polymers, polyamide-imides, polyether ether ketones (PEEK), and combinations thereof, and fracture proppant material. The method further consists of or consists essentially of flowing fluid back through the blend where the amount of the fracture proppant material flowed back is less than the fracture proppant material flowed back in the absence of the deformable particulate material.

What is claimed is:

1. A blend comprising:
deformable particulate material having an aspect ratio of greater than 1 to about 25 and comprising a material selected from the group consisting of aluminosilicate, magnesium phosphate, aluminum phosphate, zirconium aluminum phosphate, zirconium phosphate, zirconium phosphonate, carbide materials, tungsten carbide, polymer cements, high performance polymers, polyamide-imides and polyether ether ketones (PEEK), and combinations thereof; and
fracture proppant material.

2. The blend of claim 1 where the deformable particulate material is prepared by a process comprising:
mixing together an alkali metal hydroxide or an alkali metal oxide and an aluminosilicate binder in water to form a mixture in an aqueous solution; and
heating the mixture to polymerize the aluminosilicate.

3. The blend of claim 2 where in the process the aqueous solution has a mole ratio of SiO₂/Al₂O₃ ranging from about 1:1 to about 30:1.

4. The blend of claim 2 where in the process the ratio of silicate to alkali metal hydroxide or alkali metal oxide in the aqueous solution ranges from about 0.1:1 to about 6:1.

5. The blend of claim 2 where in the process the aqueous solution further comprises fillers selected from the group consisting of silica sand, Kevlar fibers, fly ash, sludges, slags, waste paper, rice husks, saw dust, volcanic aggregates, expanded perlite, pumice, scoria, obsidian, minerals, diatomaceous earth, mica, borosilicates, clays, metal oxides, metal fluorides, plant and animal remains, sea shells, coral, hemp fibers, manufactured fillers, silica, mineral fibers, mineral mats, chopped fiberglass, woven fiberglass, metal wools, turnings, shavings, wollastonite, nanoclays, carbon nanotubes, carbon fibers and nanofibers, graphene oxide, graphite, and combinations thereof.

6. The blend of claim 2 where in the process the heating is between about 20 and about 300° C.

7. The blend of claim 1 where the fracture proppant material is selected from the group consisting of white sand, brown sand, ceramic beads, glass beads, bauxite grains, sintered bauxite, sized calcium carbonate, walnut shell fragments, aluminum pellets, nylon pellets, nuts shells, gravel, resinous particles, alumina, minerals, polymeric particles, and combinations thereof.

8. The blend of claim 1 where:
the fracture proppant material has a particle size of from about 4 mesh to about 100 mesh (from about 5 mm to about 0.1 mm),
the deformable particulate material has a particle size of from about 4 mesh to about 100 mesh (from about 5 mm to about 0.1 mm), and
the ratio of fracture proppant material to deformable particulate material ranges from about 20:1 to about 0.5:1 by volume.

9. The blend of claim 1 where the deformable particulate material is shaped by extrusion and size reduction.

10. A method of fracturing a subterranean formation, comprising:
injecting a blend into a hydraulic fracture created in a subterranean formation, where the blend comprises:
deformable particulate material having an aspect ratio of greater than 1 to about 25 and comprising a material selected from the group consisting of aluminosilicate, magnesium phosphate, aluminum phosphate, zirconium aluminum phosphate, zirconium phosphate, zirconium phosphonate, carbide materials, tungsten carbide, polymer cements, high performance polymers, polyamide-imides, polyether ether ketones (PEEK), and combinations thereof; and
fracture proppant material; and
flowing fluid back through the blend where the amount of the fracture proppant material flowed back is less than the fracture proppant material flowed back in the absence of the deformable particulate material.

11. The method of claim 10 where the deformable particulate material is prepared by a process comprising:
mixing together an alkali metal hydroxide or an alkali metal oxide and an aluminosilicate binder in water to form a mixture in an aqueous solution; and
heating the mixture to polymerize the aluminosilicate.

12. The method of claim 11 where in the process of preparing the deformable particulate material the aqueous solution has a mole ratio of SiO₂/Al₂O₃ ranging from about 1:1 to about 30:1.

13. The method of claim 11 where in the process of preparing the deformable particulate material the ratio of silicate to alkali metal hydroxide or alkali metal oxide in the aqueous solution ranges from about 0.1:1 to about 6:1.

14. The method of claim 11 where in the process of preparing the deformable particulate material, the aqueous solution further comprises fillers selected from the group consisting of silica sand, Kevlar fibers, fly ash, sludges, slags, waste paper, rice husks, saw dust, volcanic aggregates, expanded perlite, pumice, scoria, obsidian, minerals, diatomaceous earth, mica, borosilicates, clays, metal oxides, metal fluorides, plant and animal remains, sea shells, coral, hemp fibers, manufactured fillers, silica, mineral fibers, mineral mats, chopped fiberglass, woven fiberglass, metal wools, turnings, shavings, wollastonite, nanoclays, carbon nanotubes, carbon fibers and nanofibers, graphene oxide, graphite, and combinations thereof.

15. The method of claim 11 where in the process of preparing the deformable particulate material the heating is between about 20 and about 300° C.

16. The method of claim 10 where the fracture proppant material is selected from the group consisting of white sand, brown sand, ceramic beads, glass beads, bauxite grains, sintered bauxite, sized calcium carbonate, walnut shell fragments, aluminum pellets, nylon pellets, nuts shells, gravel, resinous particles, alumina, minerals, polymeric particles, and combinations thereof.

17. The method of claim 10 where in the blend:
the fracture proppant material has a particle size of from about 4 mesh to about 100 mesh (from about 5 mm to about 0.1 mm),
the deformable particulate material has a particle size of from about 4 mesh to about 100 mesh (from about 5 mm to about 0.1 mm), and
the ratio of fracture proppant material to deformable particulate material ranges from about 20:1 to about 0.5:1 by volume.

18. The method of claim 10 where the amount of proppants flowed back is reduced from about 10 wt % or more less proppant produced to 100 wt %.

19. The method of claim 10 where a closure stress of the hydraulic fracture created during the injecting within the subterranean formation is from about 1000 to about 12,000 psi (about 6.9 MPa to about 83 MPa).

20. The method of claim 10 further comprising producing a fluid from the formation where the fines obtained are lower than about 10 wt %.

21. A method of fracturing a subterranean formation, comprising:
injecting a blend into a hydraulic fracture created in a subterranean formation, where the blend comprises:
deformable particulate material having an aspect ratio greater than 1 to about 25 and comprising a material selected from the group consisting of aluminosilicate, magnesium phosphate, aluminum phosphate, zirconium aluminum phosphate, zirconium phosphate, zirconium phosphonate carbide materials, tungsten carbide, polymer cements, high performance polymers, polyamide-imides, polyether ether ketones (PEEK), and combinations thereof; and
fracture proppant material selected from the group consisting of white sand, brown sand, ceramic beads, glass beads, bauxite grains, sintered bauxite, sized calcium carbonate, walnut shell fragments, aluminum pellets, nylon pellets, nuts shells, gravel, resinous particles, alumina, minerals, polymeric particles, and combinations thereof;
where in the blend:
the fracture proppant material has a particle size of from about 4 mesh to about 100 mesh (from about 5 mm to about 0.1 mm),
the deformable particulate material has a particle size of from about 4 mesh to about 100 mesh (from about 5 mm to about 0.1 mm), and
the ratio of fracture proppant material to deformable particulate material ranges from about 20:1 to about 0.5:1 by volume; and
flowing fluid back through the blend where the amount of proppants flowed back is reduced from about 10 wt % or more less proppant produced to 100 wt %.

22. A method of fracturing a subterranean formation, comprising:
injecting deformable particulate material into a fracture created in a subterranean formation in at least the near-wellbore region of the fracture, where the deformable particulate material has an aspect ratio of greater than 1 to about 25 and comprising a material selected from the group consisting of aluminosilicate, magnesium phosphate, aluminum phosphate, zirconium aluminum phosphate, zirconium phosphate, zirconium phosphonate, carbide materials, tungsten carbide, polymer cements, high performance polymers, polyamide-imides, polyether ether ketones (PEEK), and combinations thereof; and
flowing fluid back through the deformable particulate material where the conductivity through the fracture is increased as compared with an otherwise identical method where the deformable particulate material is replaced by conventional proppant.
